(19) United States
(12) Patent Application Publication
(10) Pub. No.: US 2012/0273702 A1
(43) Pub. Date: Nov. 1, 2012

(54) Electroactive Polymer Actuators and their use on Microfluidic Devices

(75) Inventors: Christopher T. Culbertson, Saint George, KS (US); Alexander K. Price, Palm Beach Gardens, FL (US)

(73) Assignee: KANSAS STATE UNIVERSITY RESEARCH FOUNDATION, Manhattan, KS (US)

(21) Appl. No.: 13/265,174

(22) PCT Filed: Apr. 19, 2010
(86) PCT No.: PCT/US10/31605

§ 371 Date: Nov. 15, 2011

Related U.S. Application Data
(60) Provisional application No. 61/247,841, filed on Oct. 1, 2009.
(60) Provisional application No. 61/170,946, filed on Apr. 20, 2009.

(51) Int. Cl. F16K 31/02

(52) U.S. Cl. 251/129.01

(57) ABSTRACT

Disclosed are electroactive polymer actuators and their use on microfluidic devices. Such actuators can comprise an electrode, an electroactive polymer, and a fluid-conducting channel. The electroactive polymer can be at least partially disposed between the electrode and the fluid-conducting channel. Furthermore, methods for creating a hydrodynamic force in a microfluidic device are disclosed by creating a potential difference across an electroactive polymer disposed on the microfluidic device.

### CROSS-REFERENCE TO RELATED APPLICATIONS

This application claims the priority benefit of U.S. Provisional Patent Application Ser. No. 61/170,946 entitled “AN INTEGRATED ELECTROACTIVE POLYMER ACTUATOR ON A MICROFLUIDIC DEVICE,” filed Apr. 20, 2009, and U.S. Provisional Patent Application Ser. No. 61/247,841 entitled “AN INTEGRATED ELECTROACTIVE POLYMER ACTUATOR ON A MICROFLUIDIC DEVICE,” filed Oct. 1, 2009, the entire disclosures of which are incorporated herein by reference.

### GOVERNMENT INTERESTS

This invention was made with U.S. Government support under grant number CHE-0548046 awarded by the National Science Foundation. The U.S. Government has certain rights to the invention.

### BACKGROUND OF THE INVENTION

1. Field of the Invention

Various embodiments of the present invention relate in general to actuators suitable for use on microfluidic devices. Particularly, embodiments of the present invention related to electroactive polymer actuators and their use on microfluidic devices.

2. Description of the Related Art

Miniaturization has enabled great improvements in the performance, speed, and portability of analysis systems. Of the many operations that can be accomplished on microfluidic devices, separations were the first to be demonstrated and remain one of the most popular. Microchip capillary electrophoresis (“μCE”) has proven to be a powerful tool for the analysis of cell-based biomolecules, such as DNA, proteins, and amino acids. Miniaturized operations that deal with aqueous and sometimes non-aqueous solutions (such as μCE) commonly utilize electric potential-driven fluid flow in order to move samples within the channel network. Electroosmotic flow (“EOF”) is created by application of an electric field in a small channel filled with a conducting liquid. It is generated without moving parts and produces a flat flow profile that limits analyte dispersion.

In a μCE separation, injections are typically produced at a channel intersection or junction by the manipulation of the electrical potentials that are applied to the fluid reservoirs. Injections can be produced in many different schemes according to the channel geometry and voltage configuration; the most common among these are pinched, double-tee, and gated injections. Pinched and double-tee injections are typically limited by invariable, design-dependent volumes and bi-directional flow in the sample, separation, and waste channels, whereas gated injections feature variable volumes defined by dt and unidirectional flow in each channel. These characteristics make gated injections more suitable for continuous flow sampling and 2-D separations. However, gated injections suffer greatly from sampling bias, which is an artifact of electrophoretic migration in an electric field. Sampling bias is an undesirable effect because the detected amounts of injected analyte do not represent the true composition of the sample, and it makes low-mobility analytes very difficult to detect. The sampling bias produced at a channel intersection during gated injections has two components: a linear flow component and a transradial flow component. The linear component is governed by the fact that analytes with different masses and charges will move at different velocities within the field, such that when the “gate” is opened, faster-moving analytes will be preferentially included in the injection. The transradial component is caused by a discrepancy in the turning radius experienced by analytes with a higher apparent Peclet number compared to those with a lower apparent Peclet number as they turn 90° from the sample channel to the sample waste channel. As a result, analytes with larger diffusion coefficients (small molecules) extend further into the intersection than large molecules and are therefore preferentially injected. Likewise, when separating mixtures of analytes with very similar diffusion coefficients, those with larger mobilities will be preferentially injected.

Sampling bias in gated injections can be reduced significantly by using large injection times, but increasing the variance associated with the injection decreases the separation efficiency and resolution. Hydrodynamic or pressure-based flow can be used to overcome biasing, but its implementation on microfluidic devices is not straightforward due to limited fluid access. Hydrodynamic injections for μCE analysis have been accomplished using hydrostatic pressure from a discrepancy in reservoir height levels, diffusion, pressurization of the reservoir using pneumatic and mechanical actuation, syringe pumps, and pneumatic valving. While all have demonstrated some measure of success in reducing sampling bias, these configurations tend to increase the complexity of the channel network architecture, produce a limited range of injection volumes, or drastically increase the time of analysis. Importantly, many of the schemes used to produce hydrodynamic injections on microchips are dependent upon the increased coupling of macroscale and microscale components. That is, the microfluidic analysis system is connected to large, off-chip equipment such as syringe pumps, pneumatic feed lines, solenoid valves, gas cylinders, vacuum pumps or electromagnetic actuators.

Thus, there remains a need for actuators for microfluidic devices that reduce or eliminate sample bias. Additionally, actuators are needed for microfluidic devices that require less and/or smaller off-chip equipment for operation.

### SUMMARY OF THE INVENTION

One embodiment of the present invention concerns an actuator for use on a microfluidic device. The actuator of this embodiment comprises: (a) an electrode; (b) a fluidic layer having a recessed portion formed therein; and (c) an electroactive polymer layer underlying at least a portion of the fluidic layer. In this embodiment, at least a portion of the electroactive polymer layer cooperates with the recessed portion of the fluidic layer to define a fluid-conducting channel, and the electrode underlies at least a portion of the fluid-conducting channel.

Another embodiment of the present invention concerns a process for creating a hydrodynamic force in a microfluidic device so as to cause a fluid to flow in said device. The process of this embodiment comprises applying a potential difference across an electroactive polymer disposed on the microfluidic device and in communication with the fluid thereby causing the electroactive polymer to deform.

### BRIEF DESCRIPTION OF THE FIGURES

Embodiments of the present invention are described herein with reference to the following drawing figures, wherein:

FIG. 1a is a top isometric view of a microfluidic device according to one embodiment of the present invention, particularly illustrating a fluidic layer comprising reservoirs and fluid-conducting channels, a substrate layer comprising an electrode, and an electroactive polymer disposed between the fluidic layer and the substrate layer;

FIG. 1b is a top view of the microfluidic device depicted in FIG. 1a, particularly illustrating the spatial relation of the electrode to the fluid-conducting channels;

FIG. 2 is an exploded isometric view of the microfluidic device depicted in FIG. 1a;

FIG. 3a is a cross-sectional view of the microfluidic device depicted in FIG. 1a taken along line 3a-3a;

FIG. 3b is a cross-sectional view of the microfluidic device depicted in FIG. 3a, particularly illustrating deformation of the electroactive polymer layer caused by introducing a potential difference across the electroactive polymer;

FIG. 3c is a cross-sectional view of the microfluidic device depicted in FIG. 3a, particularly illustrating relaxation of the electroactive polymer layer caused by removing a potential difference across the electroactive polymer;

FIG. 4 is a cross-sectional view of a microfluidic device comprising three electrodes positioned in sequence, particularly illustrating alternate charging and discharging of the electrodes;

FIG. 5 is schematic representation of an alternative microfluidic device, particularly illustrating an aqueous fluid-conducting channel positioned over an electrode, and an organic fluid-conducting channel connected thereto via a connecting channel;

FIG. 6a is an electropherogram of time versus fluorescence intensity depicting the relationship between injection size and external field strength prior to capacitor discharge;

FIG. 6b is a plot of external field strength versus peak area for the data depicted in FIG. 6a;

FIG. 7 is a plot of capacitor potential versus peak area depicting the relationship between injection size and active area of the capacitor;

FIG. 8 is a plot of external field strength versus injection length depicting the relationship between injection size and the elasticity of the dielectric elastomer of the capacitor;

FIG. 9 is a plot of migration time versus number of plates comparing samples injected electrokinetically and hydrodynamically;

FIG. 10a is an electropherogram of time versus fluorescence intensity showing 64 consecutive hydrodynamic injections of 2′,7′-dichlorofluorescein (“DCF”) over a span of 9.67 minutes;

FIG. 10b is a plot depicting migration time (top plot), peak height (middle plot), and peak area (bottom plot) for each of the 64 injections shown in FIG. 10a;

FIG. 11 is an electropherogram of time versus fluorescence intensity comparing the difference in chemical composition between electrokinetic injections and hydrodynamic injections, normalized for FITC-Arg;

FIG. 12a is plot of EAP field strength versus peak area depicting the relationship between injection volume and peak area percentage for FITC-labeled arginine for electrokinetic injections and hydrodynamic injections;

FIG. 12b is plot of EAP field strength versus peak area depicting the relationship between injection volume and peak area percentage for FITC-labeled proline for electrokinetic injections and hydrodynamic injections; and

FIG. 12c is plot of EAP field strength versus peak area depicting the relationship between injection volume and peak area percentage for FITC-labeled glutamic acid for electrokinetic injections and hydrodynamic injections.

### DETAILED DESCRIPTION

In accordance with one or more embodiments of the present invention, there is provided an actuator for use on a microfluidic device. In various embodiments, the actuator can comprise an electrode, an electroactive polymer, and a fluid-conducting channel. Additionally, various embodiments of the present invention provide a method for creating a hydrodynamic force in a microfluidic device by applying a potential difference across an electroactive polymer disposed on the microfluidic device and in communication with the fluid, thereby causing the electroactive polymer to deform. Such deformation can be reversed by removing the potential difference. Additionally, deformation and reformation of the electroactive polymer can be repeatable.

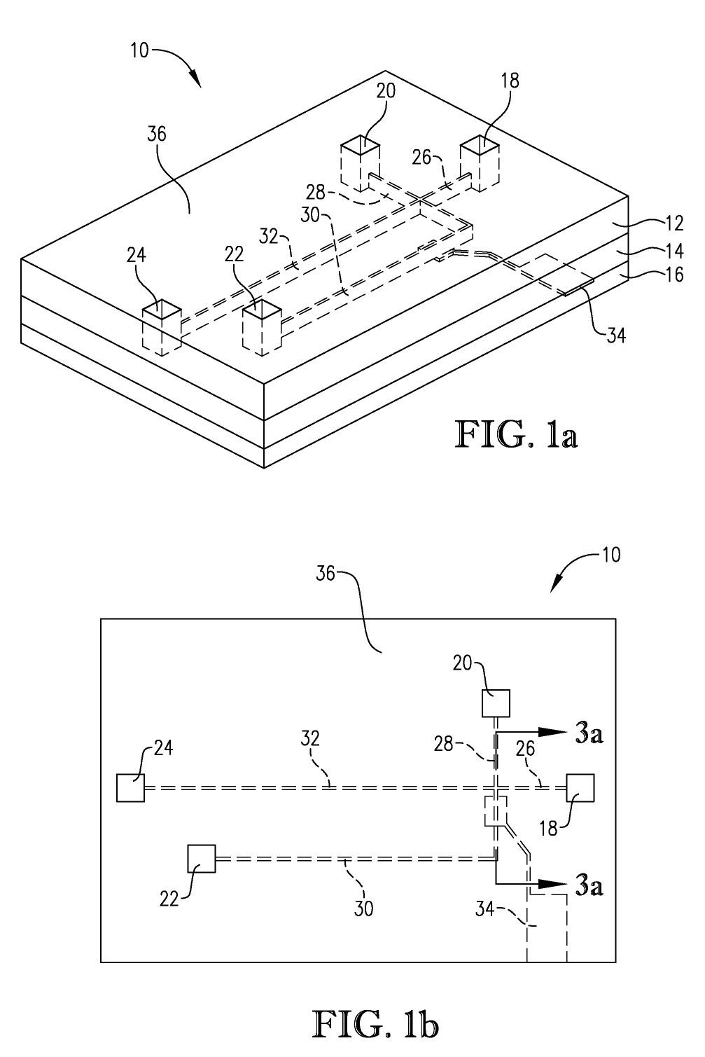

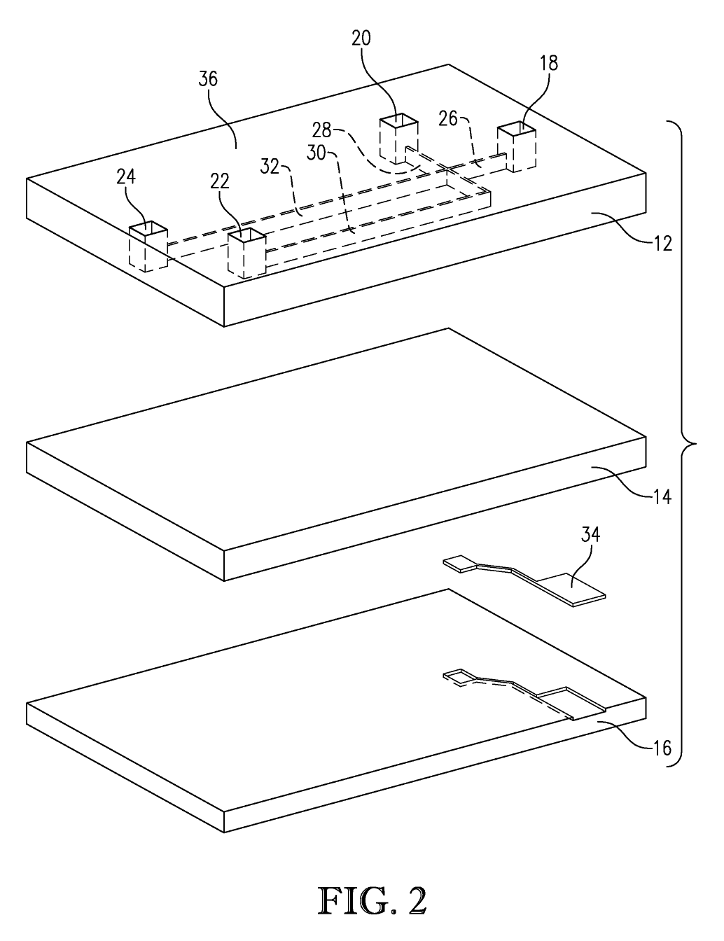

Referring initially to FIGS. 1a, 1b, and 2, a microfluidic device 10 is depicted comprising a fluidic layer 12, an electroactive polymer layer 14, and a substrate layer 16. As used herein, the term “fluidic layer” shall denote a substance through which a fluid can travel, such as by fluid-conducting channels; the term “fluidic layer” is not intended to necessarily require the fluidic layer 12 to be in a fluid state. The fluidic layer 12 comprises a sample introduction reservoir 18, a buffer introduction reservoir 20, a sample waste reservoir 22, and a buffer waste reservoir 24. Additionally, the fluidic layer 12 comprises a sample introduction channel 26, a buffer introduction channel 28, a sample waste channel 30, and a buffer waste channel 32. The substrate layer 16 comprises an electrode 34. As perhaps best seen in FIG. 1b, at least a portion of the electrode 34 underlies a portion of the sample waste channel 30.

The fluidic layer 12 can comprise any material into which fluid-conducting channels can be formed, such as by, for example, molding or etching. Also, in various embodiments, the fluidic layer 12 can comprise any material that can be bound or sealed with the electroactive polymer layer 14. In one or more embodiments, the fluidic layer 12 can comprise one or more polymers. In other various embodiments, the fluidic layer 12 can comprise glass. Examples of materials suitable for use in the fluidic layer 12 include, but are not limited to, poly(dimethylsiloxane), a poly(dimethylsiloxane)/poly(ethylene oxide) copolymer, fluorosilicones, acrylic polymers (e.g., poly(methyl methacrylate)), and mixtures of two or more thereof. In various embodiments, the fluidic layer 12 comprises poly(dimethylsiloxane). In one or more embodiments, the fluidic layer 12 and the electroactive polymer layer 14 can comprise at least one polymer in common. Furthermore, in various embodiments the fluidic layer 12 can be formed of the same or substantially the same material as the electroactive polymer layer 14, as described below.

As noted above, the fluidic layer 12 comprises the sample introduction channel 26, the buffer introduction channel 28, the sample waste channel 30, and the buffer waste channel 32. Each of the sample introduction channel 26, the buffer introduction channel 28, the sample waste channel 30, and the buffer waste channel 32 is a fluid-conducting channel. As used herein, the term “fluid-conducting channel” shall simply denote a channel through which a fluid may be permitted to pass. For ease of reference, the sample introduction channel 26, the buffer introduction channel 28, the sample waste channel 30, and the buffer waste channel 32 will be collectively referred to herein as “fluid-conducting channels.”

The fluid-conducting channels of the fluidic layer 12 can have any dimensions suitable for permitting the flow of a fluid on a microfluidic device. In one or more embodiments, the fluid-conducting channels can individually have average widths of at least about 1 μm, at least about 5 μm, at least about 10 μm, at least about 25 μm, or at least 50 μm. Additionally, the fluid-conducting channels can individually have average widths of less than 500 μm, less than 400 μm, less than 300 μm, less than 200 μm, or less than 100 μm. Furthermore, the fluid-conducting channels can individually have average widths in the range of from about 1 to about 500 μm, in the range of from about 5 to about 400 μm, in the range of from about 10 to about 300 μm, in the range of from about 25 to about 200 μm, or in the range of from 50 to 100 μm.

In one or more embodiments, the fluid-conducting channels can individually have average depths of at least about 1 μm, at least about 5 μm, or at least 10 μm. Additionally, the fluid-conducting channels can individually have average depths of less than about 100 μm, less than about 50 μm, or less than 25 μm. Furthermore, the fluid-conducting channels can individually have average depths in the range of from about 1 to about 100 μm, in the range of from about 5 to about 50 μm, or in the range of from 10 to 25 μm.

In one or more embodiments, the sample introduction channel 26 can have a length of at least about 0.01 cm, at least about 0.1 cm, or at least 0.5 cm. Additionally, the sample introduction channel 26 can have a length of less than about 30 cm, less than about 15 cm, or less than 5 cm. Furthermore, the sample introduction channel 26 can have a length in the range of from about 0.01 to about 30 cm, in the range of from about 0.1 to about 15 cm, or in the range of from 0.5 to 5 cm. In various embodiments, the sample introduction channel 26 can have a length of about 1 cm.

In one or more embodiments, the buffer introduction channel 28 can have a length of at least about 0.01 cm, at least about 0.1 cm, or at least 0.5 cm. Additionally, the buffer introduction channel 28 can have a length of less than about 30 cm, less than about 15 cm, or less than 5 cm. Furthermore, the buffer introduction channel 28 can have a length in the range of from about 0.01 to about 30 cm, in the range of from about 0.1 to about 15 cm, or in the range of from 0.5 to 5 cm. In various embodiments, the buffer introduction channel 28 can have a length of about 1 cm.

In one or more embodiments, the sample waste channel 30 can have a length of at least about 1 cm, at least about 2 cm, or at least 4 cm. Additionally, the sample waste channel 30 can have a length of less than about 50 cm, less than about 35 cm, or less than 20 cm. Furthermore, the sample waste channel 30 can have a length in the range of from about 1 to about 50 cm, in the range of from about 2 to about 35 cm, or in the range of from 4 to 20 cm. In various embodiments, the sample waste channel 30 can have a length of about 5 cm.

In one or more embodiments, the buffer waste channel 32 can have a length of at least about 1 cm, at least about 2 cm, or at least 4 cm. Additionally, the buffer waste channel 32 can have a length of less than about 50 cm, less than about 35 cm, or less than 20 cm. Furthermore, the buffer waste channel 32 can have a length in the range of from about 1 to about 50 cm, in the range of from about 2 to about 35 cm, or in the range of from 4 to 20 cm. In various embodiments, the buffer waste channel 32 can have a length of about 5 cm.

In various embodiments, the fluid-conducting channels extend only partially through the fluidic layer 12. Furthermore, the fluid-conducting channels can be formed in the fluidic layer 12 such that the fluidic layer 12 defines the upper inner surface and the side inner surfaces of the fluid-conducting channels. Thus, the fluidic layer 12, prior to being assembled in the microfluidic device 10, can present one or more recessed portions formed therein. As will be described in greater detail below, when the fluidic layer is incorporated onto the microfluidic device 10, such recessed portions can cooperate with the electroactive polymer layer 14 to define the fluid-conducting channels. Accordingly, in various embodiments, the electroactive polymer layer 14 can define the lower inner surface of the fluid-conducting channels when the microfluidic device 10 is assembled. Additionally, cross-sections of the fluid-conducting channels taken orthogonally to the direction of channel extension can have any desired shape, such as, for example, circular, semi-circular, or quadrilateral (e.g., square or rectangular). In one or more embodiments, the fluid-conducting channels can have quadrilateral or substantially quadrilateral cross-sections.

In various embodiments, the average thickness of the fluidic layer extending orthogonally from the top of the fluid-conducting channels to the upper surface 36 of the fluidic layer 12 can be at least about 0.1 mm, at least about 0.3 mm, or at least 0.5 mm. Additionally, the average thickness of the fluidic layer 12 extending orthogonally from the top of the fluid-conducting channels to the upper surface 36 of the fluidic layer 12 can be less than about 5 cm, less than about 3 cm, or less than 1 cm. Furthermore, the average thickness of the fluidic layer 12 extending orthogonally from the top of the fluid-conducting channels to the upper surface 36 of the fluidic layer 12 can be in the range of from about 0.1 mm to about 5 cm, in the range of from about 0.3 mm to about 3 cm, or in the range of from 0.5 mm to 1 cm.

As noted above, the fluidic layer 12 can define the sample introduction reservoir 18, the buffer introduction reservoir 20, the sample waste reservoir 22, and the buffer waste reservoir 24. Each of the sample introduction reservoir 18, the buffer introduction reservoir 20, the sample waste reservoir 22, and the buffer waste reservoir 24 can extend completely through the fluidic layer 12. Sample introduction reservoir 18 can be in fluid flow communication with sample introduction channel 26. Buffer introduction reservoir 20 can be in fluid flow communication with buffer introduction channel 28. Sample waste reservoir 22 can be in fluid flow communication with sample waste channel 30. Buffer waste reservoir 24 can be in fluid flow communication with buffer waste channel 32. The sample introduction reservoir 18, the buffer introduction reservoir 20, the sample waste reservoir 22, and the buffer waste reservoir 24 can individually have any desired shapes or dimensions. In various embodiments, the sample introduction reservoir 18, the buffer introduction reservoir 20, the sample waste reservoir 22, and the buffer waste reservoir 24 can individually have volumes in the range of from about 1 μL to about 1,000 μL, in the range of from about 10 to about 500 μL, or in the range of from 50 to 150 μL.

The dimensions of the fluidic layer 12 are not particularly limited, so that the fluidic layer 12 can have any width, length, and thickness suitable for use in a microfluidic device. In one or more embodiments, the fluidic layer 12 can have the same or substantially the same width and length as the electroactive polymer layer 14, described below. In one or more embodiments, the fluidic layer 12 can have an average thickness of at least about 0.5 mm, at least about 1 mm, or at least 2 mm. Additionally, the fluidic layer 12 can have an average thickness of less than about 20 mm, less than about 15 mm, or less than 10 mm. Furthermore, the fluidic layer 12 can have an average thickness in the range of from about 0.5 to about 20 mm, in the range of from about 1 to about 15 mm, or in the range of from 2 to 10 mm.

Referring still to FIGS. 1-2, the electroactive polymer layer 14 can comprise one or more electroactive polymers. As used herein, the term “electroactive polymer” shall denote any polymer that deforms in at least one dimension in response to having an electric field applied thereto. In various embodiments, polymers suitable for use in the electroactive polymer layer 14 can also be dielectric elastomer polymers. As used herein, the term “dielectric elastomer” shall denote any elastomeric polymer that is an electrical insulator. Classes of dielectric elastomers suitable for use in the electroactive polymer layer 14 include, but are not limited to, siloxane polymers and acrylic polymers. Examples of electroactive polymers suitable for use in the electroactive polymer layer 14 include, but are not limited to, poly(dimethylsiloxane), a poly(dimethylsiloxane)/poly(ethylene oxide) copolymer, a fluorosilicone, an acrylic polymer (e.g., poly(methyl methacrylate)), and mixtures of two or more thereof. In one or more embodiments, the electroactive polymer layer 14 comprises poly(dimethylsiloxane).

It should be noted that, although the electroactive polymer layer 14 is referred to herein as an “electroactive polymer” layer, it is not necessary for the entire electroactive polymer layer 14 to be formed from an electroactive polymer, with the proviso that the actuator region of the electroactive polymer layer 14 (i.e., the portion of the electroactive polymer layer 14 disposed between the electrode 34 and the sample waste channel 30) comprises an electroactive polymer. In one or more embodiments, the electroactive polymer layer 14 comprises an electroactive polymer in an amount of at least 50, at least 60, at least 70, at least 80, at least 90, or at least 99 weight percent. In other embodiments, the electroactive polymer layer 14 can be formed entirely or substantially entirely of an electroactive polymer.

In addition to one or more electroactive polymers, the electroactive polymer layer 14 can further comprise one or more curing agents. The curing agent can be present in an amount in the range of from about 1 to about 50 weight percent, or in the range of from about 5 to about 20 weight percent, based on the total weight of electroactive polymer in the electroactive polymer layer 14.

The dimensions of the electroactive polymer layer 14 are not particularly limited, so that the electroactive polymer layer 14 can have any width, length, and thickness suitable for use in a microfluidic device. In one or more embodiments, the electroactive polymer layer 14 can have the same or substantially the same width and length as the fluidic layer 12. In one or more embodiments, the electroactive polymer layer 14 can have an average thickness of at least about 5 μm, at least about 10 μm, or at least 20 μm. Additionally, the electroactive polymer layer 14 can have an average thickness of less than about 200 μm, less than about 100 μm, or less than 60 μm. Furthermore, the electroactive polymer layer 14 can have an average thickness in the range of from about 5 to about 200 μm, in the range of from about 10 to about 100 μm, or in the range of from 20 to 60 μm. In various embodiments, the electroactive polymer layer can have an average thickness of about 40 μm.

Referring still to FIGS. 1-2, the substrate layer 16 can comprise any materials suitable for use as a substrate in a microfluidic device. In one or more embodiments, the substrate layer 16 can comprise glass, one or more plastics, or mixtures thereof. The dimensions of the substrate layer 16 are not particularly limited, so that the substrate layer 16 can have any width, length, and thickness suitable for use in a microfluidic device. In one or more embodiments, the substrate layer 16 can have the same or substantially the same width and length as the fluidic layer 12 and/or the electroactive polymer layer 14.

As noted above, the substrate layer 16 can have the electrode 34 disposed thereon. The electrode 34 can be formed from any electrically conducting materials now known or hereafter discovered in the art. Materials suitable for use in electrode 34 include, but are not limited to, one or more metals, carbon graphite, indium tin oxide, or mixtures of two or more thereof. In one or more embodiments, the electrode 34 can comprise chrome. Additionally, the electrode 34 can be incorporated on the substrate layer 16 employing any now known or hereafter discovered methods in the art. In various embodiments, the electrode 34 can be incorporated on the substrate layer 16 via photolithography and wet chemical processing (etching).

As perhaps best seen in FIG. 1b, at least a portion of the electrode can underlie a portion of the fluid-conducting channels of the fluidic layer 12. Specifically, in the embodiment of FIG. 1b, the electrode 34 underlies a portion of the sample waste channel 30. The portion of the microfluidic device 10 where the sample waste channel 30 and the electrode 34 overlap defines an actuator area. In one or more embodiments, the actuator area of the microfluidic device 10 can have a horizontal cross-sectional area of at least about 0.01 mm², at least about 0.05 mm², or at least 0.1 mm². Additionally, the actuator area of the microfluidic device 10 can have a cross-sectional area of less than about 5 mm², less than about 3 mm², or less than 1 mm². Furthermore the actuator area of the microfluidic device 10 can have a horizontal cross-sectional area in the range of from about 0.01 to about 5 mm², in the range of from about 0.05 to about 3 mm², or in the range of from 0.1 to 1 mm².

In one or more embodiments, the electrode 34 can be a fixed electrode. As used herein, the term “fixed” shall denote that the electrode 34 is affixed in a certain spatial relationship to the fluid-conducting channels of the fluidic layer 12. In one or more embodiments, the distance between the intersection of sample introduction channel 26 and buffer introduction channel 28 and the electrode 34 can be less than about 1,000 μm, or in the range of from about 200 to about 800 μm. In additional various embodiments, though not depicted, it is contemplated within the scope of this invention that electrode 34 could be placed in direct contact with electroactive polymer layer 14 without the use of a substrate, such as substrate layer 16.

In one or more embodiments, the electrode 34 can be electrically coupled to a power source (not depicted). Coupling the electrode 34 to a power source can be accomplished by any methods now known or hereafter discovered in the art. In one or more embodiments, the power source coupled to the electrode 34 can have a fast slew rate. For example, the power source can have a slew rate of less than 5 milliseconds, less than 3 milliseconds, or less than 2 milliseconds. Additionally, the power source can be a high-voltage but low current power supply such that power supplied to the electrode 34 is in the milliwatt range.

The method employed for preparation of the microfluidic device 10 is not particularly limited, such that the microfluidic device 10 can be prepared by any now known or hereafter discovered methods in the art. In one non-limiting example, the microfluidic device 10 could be prepared according to the following procedure. After incorporation of the electrode 34 on the substrate layer 16 (as discussed above), the electroactive polymer layer 14 can be coated on the substrate layer by any known or hereafter discovered physical or chemical film deposition methods. In one or more embodiments the electroactive polymer layer can be incorporated onto the substrate layer 16 via spin coating. The speed and time employed for the spin coating process can be varied depending on the desired thickness of the electroactive polymer layer 14. The fluidic layer 12 can be separately prepared by pouring the desired material (such as those discussed above) into a mold having negatives of the desired fluid-conducting channels and allowing the fluidic layer 12 to set or partially set. Thereafter, the fluidic layer 12 can be removed from the mold and placed in conformal contact with the electroactive polymer layer 14 that has been formed on the substrate layer 16. The fluidic layer 12 and the electroactive polymer layer 14 can then be further cured together at an elevated temperature (e.g., 80° C.) over a period of time (e.g., 1 hour). After curing the electroactive polymer layer 14 and the fluidic layer 12, the above-described reservoirs can be punched into the fluidic layer 12 to provide access to the fluid-conducting channels.

As mentioned above, various embodiments of the present invention provide a method for creating a hydrodynamic force in a microfluidic device. In operation, the hydrodynamic force can be created by applying a voltage to the electrode 34 in order to create a potential difference across the electroactive polymer layer 14 above the electrode 34, thereby deforming the electroactive polymer layer 14. Following deformation, the potential difference can be removed and the electroactive polymer layer 14 can return to its original or substantially original shape. Such deformation and reformation sequence can be repeated as desired. As discussed in greater detail below, this process can be assisted by flowing a buffer solution in the fluid-conducting channel located above the portion of the electroactive polymer layer 14 positioned above the electrode 34. The buffer solution can have a voltage applied thereto and/or the buffer solution can be connected to ground via electrodes (e.g., wires) positioned in the sample introduction reservoir 18, the buffer introduction reservoir 20, the sample waste reservoir 22, and/or the buffer waste reservoir 24. Thus, in various embodiments, the above-described system can act as a capacitor, with the electrode 34 and the buffer solution in the fluid-conducting channel acting as the opposing conductors and the electroactive polymer acting as the dielectric material.

During operation, the electric potential across the electroactive polymer layer 14 located above the electrode 34 (“V_{cap}”) can be described by the following equation:

V_{cap}=V_{electrode}−V_{channel}

where V_{electrode} is the potential that is applied to the electrode 34 and V_{channel} is the average potential that exists in the buffer solution in the fluid-conducting channel above the electrode. V_{channel} is dependent upon the potentials applied in the buffer and sample reservoirs. During operation, V_{cap} can be varied in order to actuate (deform) the electroactive polymer layer 14. The amount of V_{cap} employed can vary depending on the desired amount of hydrodynamic force to be created. In one or more embodiments, the V_{cap} can be at least about 1, at least about 5, or at least 10 V per micrometer of the electroactive polymer layer 14 extending between electrode 34 and sample waste channel 30 (“V/μm”). Additionally, V_{cap} can be less than about 100, less than about 80, or less than 60 V/μm. Furthermore, the V_{cap} can be in the range of from about 1 to about 100, in the range of from about 5 to about 80, or in the range of from 10 to 60 V/μm. It should be noted that the upper limit of V_{cap} may depend on the electric breakdown point of the electroactive polymer layer 14.

In various embodiments, the V_{cap} can initially be held at 0 by holding V_{channel} equal or substantially equal to V_{electrode} (e.g., V_{channel}=V_{electrode}=1,000 V). Thus, to create a potential difference across the electroactive polymer layer 14, either V_{channel} or V_{electrode} can be increased or decreased. Accordingly, during actuation, V_{cap} can be either positive or negative, depending on how the potential to the electrode 34 or the buffer solution in the sample waste channel 30 is varied. Therefore, the above values provided for V_{cap} are intended to be absolute values (e.g., V_{cap} can be in the range of from about |1| to about |100| V/μm).

As mentioned above, a voltage can be applied to the electrode 34 and/or the buffer solution in the sample waste channel 30 in order to create a potential difference across the electroactive polymer layer 14. In one or more embodiments, the amount of voltage applied to electrode 34 during operation can be in the range of from about 0.1 to about 10,000 V, in the range of from about 0.5 to about 8,000 V, or in the range of from about 1 to about 6,000 V. Similarly, the amount of voltage applied to any of the sample introduction reservoir 18, the buffer introduction reservoir 20, the sample waste reservoir 22, and/or the buffer waste reservoir 24 can be in the range of from about 0.1 to about 10,000 V, in the range of from about 0.5 to about 8,000 V, or in the range of from about 1 to about 6,000 V. In one or more embodiments, the sample introduction reservoir 18 and the buffer introduction reservoir 20 can have a voltage applied thereto, while the sample waste reservoir 22 and the buffer waste reservoir 24 can be connected to ground.

During operation of the microfluidic device 10, such as for micro-capillary electrophoresis, a sample solution can initially be introduced into sample introduction reservoir 18 and a buffer solution can initially be introduced into buffer introduction reservoir 20. The flow of buffer and sample solutions can initially be induced into the fluid-conducting channels either by vacuum or capillary action. The sample solution can contain any desired analyte, such as, for example, proteins, DNA, RNA, peptides, amino acids, PAHs, PCBs, steroids, small organic molecules, ions, or mixtures of two or more thereof. Additionally, the sample solution can comprise one or more electrolyte solutions (i.e., a buffer). Similarly, the buffer solution can comprise one or more electrolyte solutions. Electrolyte solutions suitable for use in the sample solution and/or the buffer solution include, for example, sodium borate, sodium phosphate, any Good buffer solution (e.g., MES, ADA, PIPES, ACES, cholamine chloride, BES, TES, HEPES, acetamidoglycine, tricine, blycinamide, bicine), or mixtures of two or more thereof. Additionally, the sample solution and/or the buffer solution can have a pH of at least about 7, at least about 8, or at least 9.

In various embodiments, the flow of the buffer solution and sample solution can be controlled, so that they have equal or substantially equal mass flow rates. This ensures that, upon meeting at the intersection of sample introduction channel 26 and buffer introduction channel 28, the sample solution flows into sample waste channel 30, and the buffer solution flows into buffer waste channel 32. Injections of the sample solution can be performed by actuating the above-described electroactive polymer actuator, such that when the potential across the electroactive polymer layer 14 is discharged, sample solution is expelled both upstream and downstream. At least a portion of the sample solution expelled upstream can enter the buffer waste channel 32, where it can be analyzed if desired.

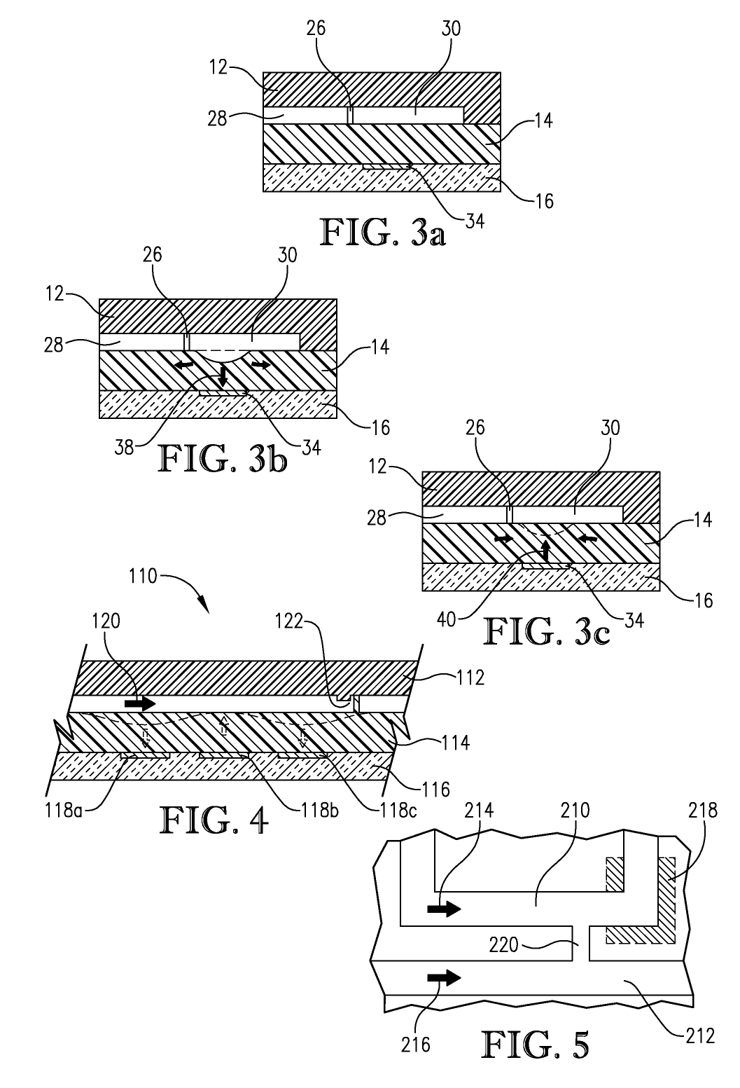

Referring now to FIGS. 3a-c, a cross-sectional view of the microfluidic device 10 is depicted illustrating the actuator area defined by the electrode 34, the electroactive polymer layer 14, and the sample waste channel 30. As illustrated in FIG. 3b, when the voltage applied to the electrode 34 differs from the voltage of the fluid in the sample waste channel 30, the electroactive polymer layer 14 can deform in the directions of the arrows 38, thereby causing an increase in volume in sample waste channel 30. In one or more embodiments, the volume in sample waste channel 30 at the actuator area can increase during operation an amount of at least about 1 percent, at least about 5 percent, at least about 10 percent, or at least 20 percent. Additionally, as will be understood by those skilled in the art, creating a potential difference across the electroactive polymer layer 14 will cause a Maxwell stress in the electroactive polymer layer 14 at the region overlying the electrode 34. In one or more embodiments, the Maxwell stress caused in the electroactive polymer layer 14 during actuation can be in the range of from about 0.01 to about 60 kPa. As illustrated in FIG. 3c, when the potential difference across the electroactive polymer layer 14 is discharged, the electroactive polymer layer 14 can return to its previous relaxed state, as indicated by the arrows 40. During operation, the deformation and relaxation sequence just described can be repeated for at least 5, at least 10, at least 25, or at least 50 sequences.

Another embodiment of the present invention contemplates the use of a plurality of fixed electrodes in a microfluidic device, such as the microfluidic device 10 described above. FIG. 4 illustrates such an embodiment. In FIG. 4, a cross-section of a microfluidic device 110 is depicted having a fluidic layer 112, an electroactive polymer layer 114, and a substrate layer 116 comprising three electrodes 118a-c. The fluidic layer 112, the electroactive polymer layer 114, the substrate layer 116, and the electrodes 118a-c can all be substantially the same as the fluidic layer 12, the electroactive polymer layer 14, the substrate layer 16, and the electrode 34, respectively, described above with reference to FIGS. 1a, 1b, and 2. In the embodiment of FIG. 4, the electrodes 118a-c can optionally be actuated in sequence to operate as a pump. Such operation can induce a fluid to travel in the direction of arrow 120. Operation of the microfluidic device 110 can be substantially the same as the operation of the microfluidic device 10, described above with reference to FIGS. 1a, 1b, and 2. Additionally, microfluidic device 110 can have a check valve 122 disposed in the fluid-conducting channel to facilitate fluid pumping by sequential actuation of electrodes 118a-c. The check valve 122 is employed to ensure unidirectional flow of fluid through the microfluidic device 110. It should be noted that, although the fluidic device 110 is depicted having three electrodes (i.e., the electrodes 118a-c), a check valve, such as the check valve 122, can also be employed in microfluidic devices having fewer fixed electrodes (e.g., 1 or 2). In various embodiments, a check valve, such as the check valve 122, can be employed in any of the embodiments described above with respect to FIGS. 1-3. The flow rate of a fluid in the microfluidic device 110 can be varied by three different ways: (1) changing the frequency at which the actuators operate, (2) changing the phase difference of the electrical waveforms applied to the separate electrodes 118a-c, or (3) changing the magnitude of the potential difference applied across the electroactive polymer layer 114. In various embodiments, actuator frequencies can vary in the range of from about 5 to about 80 Hz.

FIG. 5 depicts a schematic view of another embodiment of the present invention where an actuator can be employed on a microfluidic device. The system depicted in FIG. 5 is a segmented flow system where plugs of aqueous solutions can be introduced into immiscible organic media (such as fluorocarbon oil or silicone oil) and can be carried through long channel networks without dilution or dispersion. In the system of FIG. 5, an aqueous phase can flow through aqueous channel 210 while an organic phase can flow through organic channel 212 in the direction of arrows 214 and 216, respectively. When the electrode 218 is charged and discharged, a portion of the expelled aqueous phase can travel through the connecting channel 220 and be introduced into the organic phase flowing through channel 212. In various embodiments, a check valve, such as the check valve 122 described above with respect to FIG. 4, can be employed at various positions of the aqueous channel 210, the organic channel 212, and/or the connecting channel 220 to ensure unidirectional flow.

Still another embodiment of the invention contemplates the use of the above-described actuators for use in cell lysis procedures. In a system with a cell traveling in a fluid-conducting channel, the discharge of a charged electrode in an actuator such as described above can expel an amount of fluid. The shear stress caused by such expulsion can rapidly rupture the membrane of the cell (e.g., a mammalian cell) that is traveling countercurrent to the expelled fluid.

Still other embodiments of the current invention contemplate the use of the above-described actuators for use as valves or mixers on microfluidic devices. For instance, the above-described actuators could be employed as a valve by shaping an electroactive polymer such that, in its relaxed state (i.e., V_{cap}=0), it blocks the flow of a fluid through a fluid-conducting channel, but in its deformed state (i.e., V_{cap}≠0) would permit passage of the fluid through the fluid-conducting channel. Still other uses of the actuators described herein will be apparent to those skilled in the art.

This invention can be further illustrated by the following examples of embodiments thereof, although it will be understood that these examples are included merely for the purposes of illustration and are not intended to limit the scope of the invention unless otherwise specifically indicated.

### EXAMPLES

### Materials and Methods

The following materials were employed in one or more of the examples, below. Sodium borate, sodium bicarbonate, dimethyl sulfoxide (“DMSO”), and 2-propanol were obtained from Fisher Scientific (Pittsburgh, Pa.). Sodium dodecyl sulfate (“SDS”) was obtained from Sigma Chemical Co. (St. Louis, Mo.). 2′,7′-dichlorofluorescein (“DCF”) was obtained from Acros Organics (Morris Plains, N.J.). Poly(dimethylsiloxane) (“PDMS;” Sylgard 184 and Sylgard 527 silicone elastomer kits) was obtained from Dow Corning (Midland, Mich.). All of these chemicals were used as received. Arginine, proline, and glutamic acid were obtained from MP Biomedical (Solon, Ohio). Fluorescein-5-isothiocyanate (“FITC”) was purchased from Invitrogen (Molecular Probes, Carlsbad, Calif.). Derivitization of the amino acids with FITC was performed as recommended by the fluorophore manufacturer according to instructions packaged with the probe. The labeling reaction was accomplished by combining an excess of amino acid solution with amine-reactive FITC. Briefly, each amino acid was dissolved in 150 mM sodium bicarbonate buffer (pH=9.1) at a concentration of 5 mM. To make the labeling component, 1 mL of DMSO was added to the vial containing 5.3 mg of FITC. 450 μL of the amino acid solution (a 3.3× molar excess) was then added to 50 μL of FITC/DMSO solution in a micro centrifuge tube and the reaction was allowed to proceed on a shaker for approximately 4 hours in the dark. This protocol yielded a stock solution of FITC-labeled amino acids at a concentration of 1.36 mM. The distilled, deionized water used to prepare every solution in the following examples was purified with an E-pure system (Barnstead, Dubuque, Iowa). The buffer and sample solutions described below were filtered immediately before introduction to the microchip reservoirs using syringe-driven 0.45 μm PVDF filters (Fisher Scientific).

### Microscopy

In the following examples, the thickness of the EAP layer of the below-described microfluidic device was measured by visualizing a cross-section of the PDMS component of the device on a Nikon SMZ1500 stereo microscope (Nikon Instruments Inc., Melville, N.Y.). Images were captured using a Nikon Digital Sight camera and analyzed using Nikon ACT-2U software. For recording injection sequences, the microchip was placed on the stage of a Nikon Eclipse TE2000-U inverted microscope. Voltages were applied to the fluid reservoirs with a Bertan high-voltage (0-10 kV) power supply (Hauppauge, N.Y.) having five separate units that were independently controlled by Labview software (National Instruments, Austin, Tex.). An epiluminescence system having a mercury arc lamp and Nikon B-2A filter block were used to produce 450-490 nm light. The light was focused on the cross chip intersection with a 10× objective (Nikon) and the subsequent emission was collected with that same objective and captured by a high resolution Sony CCD color video camera. Movies were recorded and analyzed using Roxio Videowave movie creation software.

### EAP Elasticity Determination

Elasticity measurements were performed on rectangular sections of polymer 2.5 cm long with a uniform cross-sectional area. Briefly, one end of the polymer was attached to the ceiling and mass was added to the other end of the polymer until either the polymer sheared or the attachment clips failed. Compressive elasticity was assumed to be approximately the same as tensile elasticity.

### Electrophoresis

In the following examples, the microfluidic device channels were prepped only with the run buffer. The run buffer used in all experiments consisted of 5 mM sodium borate with 1.5 mM SDS (pH=9.2). Voltages were applied to the sample and buffer introduction reservoirs according to Kirchoff's laws and the buffer waste and sample waste reservoirs were connected to ground. Injections were made solely by altering the potential applied to the fixed electrode while the potentials applied to the buffer and sample introduction reservoirs were held constant. The response of the fluid flow to the charging and discharging of the capacitor was investigated visually on the inverted microscope. The potential difference across the electroactive polymer (“EAP”), V_{cap}, is expressed by the following equation:

V_{cap}=V_{electrode}−V_{channel}

where V_{electrode} is the potential that is applied to the fixed electrode and V_{channel} is the average potential that exists in the channel above the electrode and is dependent upon the potentials applied in the buffer and sample reservoirs. In order to have a negligible electric field across the EAP, V_{electrode} was held roughly equal to V_{channel}. This condition represents the uncharged or discharged state of the EAP capacitor. Increasing or decreasing V_{electrode} a predetermined amount produced the charged state of the EAP capacitor. Due to the fact that V_{channel} is a non-zero value, V_{cap} can be both positive and negative without changing the polarity of the high voltage power supplies.

### Single-Point Detection Apparatus

A 10 mW Nd:YAG laser (BCL-010, CrystaLaser, Reno, Nev.) that produced light at 473 nm was used as the excitation source in the following examples. The laser beam was reflected off of a 500 nm long pass dichroic mirror (Omega Optical, Brattleboro, Vt.) and focused through a 40× objective (Creative Devices, Neshanic Station, N.J.) into the microchip. The microchip was immobilized on a plexiglass holder (made in-house) that was mounted on a 1-inch x-y translation stage working in tandem with a z-axis optical holder for the objective (Thor Labs, Newton, N.J.). Fluorescent emission was collected back through the objective and passed through the dichroic mirror. Prior to detection, the light was spatially and spectrally filtered using a 400 mm pinhole and a 545 nm bandpass filter (Omega Optical). Light intensity was transduced with a photomultiplier tube (Hamamatsu, Bridgewater, N.J.) and the resulting current was amplified with a low noise current preamplifier (Stanford Research Systems, Sunnyvale, Calif.) using an electronic low pass filter. Data was sampled at rates between 250 and 750 Hz using a PCI-6036E multifunction I/O card (National Instruments) in a computer. All of the optical components, the microchip platform and the PMT were housed in a light-excluding box (80/20 Inc., Columbia City, Ind.).

Potentials were applied to the microchip with a high-voltage (0-6 kV) power supply that consisted of three separate units. Each unit could be independently controlled. This instrument was fabricated by the Electronics Design Laboratory at Kansas State University. Control of the high-voltage units and data acquisition was accomplished with a Labview software program that was written in-house. Finally, all data analysis was performed using both a Labview program written in-house and Igor Pro software (Wavemetrics, Portland, Oreg.).

### Analyzing the Electrical Potentials in the System

In all of the following examples, a separation field strength of 500 V/cm was used. To accomplish this, 3,160 V was applied to the buffer introduction reservoir and 2,800 V was applied to the sample introduction reservoir (FIG. 1b). Both of the waste reservoirs were connected to ground. In accordance with Kirchoff's and Ohm's laws, the potential present at the channel intersection was approximately 2,475 V (less than ±5% error) with this configuration. To a first approximation, V_{channel} was generally calculated as the average potential present in the sample waste channel across the length of the fixed electrode (FIG. 1b). This calculation assumed the voltage in the channel dropped 500 V/cm between the intersection and sample waste reservoir. For devices with capacitor areas of 0.05, 0.25, 0.50, 1.25, and 2.00 mm², V_{channel} values of 2,480, 2,360, 2,240, 1,840, and 1,480 V, respectively, were employed.

### Example 1

### Microfluidic Device Fabrication

### Photomasks

The photomasks employed for device fabrication were produced by a photoplotting process at 40,000 dots per inch (“dpi”) by Fineline Imaging (Colorado Springs, Colo.). The mask designs were created in AutoCAD2006LT (Thompson Learning, Albany, N.Y.) and sent to the manufacturer for production. In these Examples, two sets of masks were used: one mask for the fabrication of the fluidic network and then a series of masks that were used to create chrome electrodes of different lengths. The cross-shaped mask (i.e., the fluidic network) comprised lines with a width of 50⁻ μm and the following lengths, based on the above-description of FIG. 1: sample introduction reservoir to intersection: 1 cm; buffer introduction reservoir to intersection: 1 cm; intersection to sample waste reservoir: 5 cm; and intersection to buffer waste reservoir: 5 cm. The other masks comprised electrode patterns having widths of 3 mm and lengths of either 1 mm, 5 mm, 10 mm, 25 mm, or 40 mm. These lengths provided electrodes that produced active capacitor areas of approximately 0.05, 0.25, 0.5, 1.25, and 2 mm² on the EAP film when determined along with the channel dimensions.

### Electrode Fabrication

Photomask blanks (Telic Co., Valencia, Calif.) having 4×4 inch dimensions were used to fabricate the electrode bases. These blanks were white crown glass substrates (0.9 mm thick) coated with 120 nm of chrome and 530 nm of AZ1500 positive photoresist. A 40,000 dpi photomask displaying the desired electrode pattern was placed on top of the blank and then exposed to UV radiation from a near-UV flood exposure system (Newport Oriel, Stratford, Conn.). After development of the unpolymerized photoresist, the slide was placed in a ceric sulfate solution until the unprotected chrome was etched away. After rinsing with copious amounts of water, the electrode base was rinsed with (in order) ethanol, acetone, and ethanol again to remove the remaining photoresist. Due to the size of the original photomask blank, two different electrode bases could be fabricated simultaneously. A dicing saw (Sherline model 5410, Vista, Calif.) was used to cut the blank into two 2×3 inch slides containing electrodes.

### SU-8 Mold Fabrication

The fabrication of molds using SU-8 photoresist was based on previously published methods. Briefly, a 4 inch silicon wafer (Silicon Inc., Boise, Id.) was coated with SU-8 2010 negative photoresist (MicroChem Corp., Newton, Mass.) using a spin-coater (Laurell Technologies, North Wales, Pa.). The SU-8 was spun at 500 rpm for 5 seconds followed by 1,000 rpm for 30 seconds. The photoresist was baked on a hotplate at 90° C. for 5 minutes prior to UV exposure. An exposure dose of about 180 mJ/cm² using a near-UV flood exposure system was delivered to the substrate through a negative mask containing the channel pattern. Following this exposure, the wafer was baked at 90° C. for 5 minutes and developed in propylene glycol monomethyl ether acetate (“PGMEA”). This protocol produced SU-8 structures that were approximately 20 μm tall. The thickness of the photoresist was measured with an XP-2 profilometer from Ambios Technology (Santa Cruz, CA) and this structure height corresponded to the depth of the resulting PDMS channels.

### Device Fabrication

To produce a device with an EAP layer approximately 40 μm thick, a 20:1 (w/w) or 10:1 (w/w) PDMS (Sylgard 184)-to-curing agent mixture was applied to the glass slide with the electrode pattern and spun at 2,000 rpm for 45 seconds. To produce a device with an EAP layer the same thickness (i.e., ˜40 μm) with a 3:1 (w/w) mixture of 1:1 (w/w) Sylgard 527/10:1 (w/w) Sylgard 184, the activated polymer was applied to the electrode-containing slide and spun at 1,000 rpm for 45 seconds. Also, a 10:1 PDMS mixture was poured onto the mold containing the fluidic channels. Both of these PDMS segments were allowed to partially cure for less than 15 minutes at 80° C., after which time the PDMS layer containing the fluidic channels was peeled off its mold, and aligned over the PDMS layer covering the electrode such that the fixed electrode was directly below a portion of the sample waste channel near the intersection (see FIG. 1b). The two layers were brought into conformal contact, and cured together at 80° C. for 1 hour. Afterwards, reservoirs were punched in the PDMS to allow access to the channels, glass reservoirs were attached, and a wire was epoxied onto the device to provide electrical contact between the fixed electrode and a high-voltage power supply. Colloidal silver (Ted Pella, Inc., Redding, Calif.) was applied to ensure electrical contact between the wire and the fixed electrode.

### Example 2

### Control of Injections Using EAP Actuator

Employing a microfluidic device substantially as shown in FIGS. 1a-b and prepared as described in Example 1, a standard voltage sequence was applied to the fixed electrode in order to make an injection into the buffer waste channel (a.k.a., the separation channel). Initially, V_{electrode} was held at approximately the same value as V_{channel}. In this configuration, the EAP actuator was in its relaxed state since the electric field across it was negligible (time point 1). When V_{electrode} was changed and the capacitor was charged, the EAP layer was compressed and stretched. The EAP compression resulted in an increase in the volume of the channel above the actuator and caused additional buffer to be hydrodynamically pulled into the sample waste channel (time point 2). Once the additional volume was filled, the stream paths at the intersection quickly returned to their original positions because the linear flow rate of each stream was inversely related to the in-channel field strength, and this did not change significantly when the capacitor was charged. When V_{electrode} was changed back to the same voltage as V_{channel}, the capacitor was discharged and the EAP relaxed back to its original shape. This returned the channel to its original volume, which expelled extra fluid into the buffer and separation channels (time point 3). Once the excess volume was expelled, the stream paths again returned to their original positions. The analyte that was forced into the buffer and separation channels was injected (time point 4).

### Example 3

### Quantifying Actuator Size Change

It should be noted that the changes in the volume of the channel that occurred in the active area of the capacitor as it was charged and discharged have been confirmed in a separate experiment. It is difficult to directly measure the change in channel depth that EAP compression produces, so instead the stretching of the channel width was monitored when an electric field was applied across the EAP layer. For this example, the device was constructed on a glass substrate with an indium tin oxide (“ITO”) electrode. The transparency of the ITO electrode allows for imaging of the channel segment that lies directly over it. Potentials were applied to the reservoirs to achieve a separation field strength of 500 V/cm. The potential applied to the ITO electrode was altered between two values (V_{electrode}=Vₑₕₐₙₙₑₗ and V_{electrode}=V_{channel}−2000 V) in order to charge and discharge the capacitor. When the capacitor was charged, the channel width expanded due to x- and y-directional EAP stretching. When the capacitor was discharged, the channel width relaxed back to its original size. From video still frames, the change in channel width was calculated to be approximately 3 percent.

### Example 4

### Dependence of Injection Volume on V_{cap} and Active Capacitor Area

To determine how the magnitude and sign of V_{cap} impacted the injection process, a set of experiments was designed in which the injection plug size was analyzed both qualitatively and quantitatively. Fluorescence micrographs were taken on a device with a 20:1 PDMS EAP layer and active capacitor area (“Aₑₗ”) of 0.5 mm². The micrographs of the channel intersection were obtained less than 66 ms (two video frames) after discharging the capacitor, and show the extent of hydrodynamic DCF movement against the electrokinetic flow generated from the buffer introduction reservoir. As V_{cap} was increased, the injections became larger. This progression was due to increasingly larger changes in channel volume that were induced by the application of the electric field across the EAP.

To investigate the relationship between injection size and V_{cap} more quantitatively, injections were performed on a single-point laser setup. In the injection sequence, V_{cap} was initially held at approximately zero. After an arbitrary dead time, the capacitor was charged (V_{cap}≠0) and remained charged for 1 second before being discharged. This sequence was repeated to produce between 3 and 5 injections per run. Peaks of the analyte, a 10 μM DCF solution, were detected 0.508 cm downstream of the intersection. Also, the horizontal distance separating the channel intersection and the electrode (FIGS. 1a and 1b) was between 450 and 550 microns for every device investigated by single-point laser induced fluorescence detection. For each device with a different active capacitor area, two runs of triplicate injections were recorded.

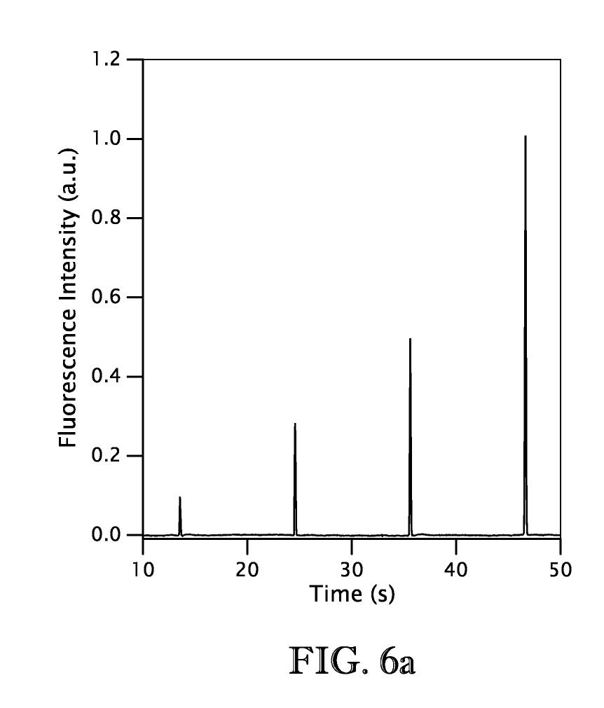

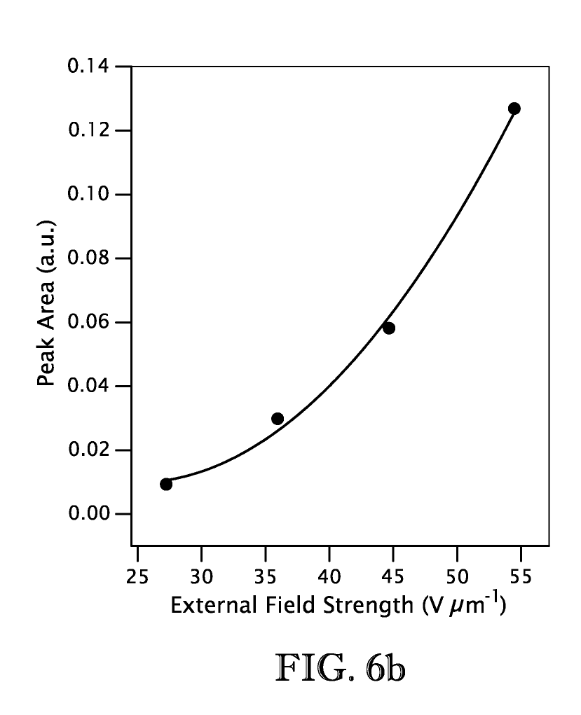

As a simple illustration of performance, FIGS. 6a and 6b show that the response of the actuator (represented by peak area, FIG. 6a) increases as the magnitude of the electric field across the EAP (FIG. 6b) increases. This data was derived from a single run that consisted of four injections with successively larger V_{cap} (FIG. 6a). As seen in the graph, the peak areas appear to increase quadratically (FIG. 6b) with the magnitude of the electric field that is applied across the EAP. Of particular note is that the quadratic behavior observed is consistent with data obtained for EAP configurations that use thickened electrolyte solutions as the compliant electrodes. Moreover, this quadratic behavior is also consistent with the Mooney-Rivlin model for thickness strains between 0% and −40%. The exact relationship, however, is somewhat complicated for several reasons. First, the magnitude of the electroosmotic flow (“EOF”) originating from the sample and buffer introduction reservoirs opposes the flow of the fluid expelled from the capacitor region and limits the amount of analyte injected. Second, the volume of fluid expelled above the fixed electrode could theoretically move in both directions in the channel, but it is highly sensitive to the hydrodynamic resistance in the channel upstream and downstream from the actuator region. Third, it is assumed that Δz is not uniform across the width of the channel. Fourth, the electric field across the EAP is not uniform over the entire area of the capacitor. This is because the in-channel potential gradient that produces electroosmotic flow is matched on the other side of the capacitor with a constant voltage at the fixed electrode (FIG. 1b). This means that Δz will not be uniform from the injection cross side to sample waste reservoir side of the fixed electrode.

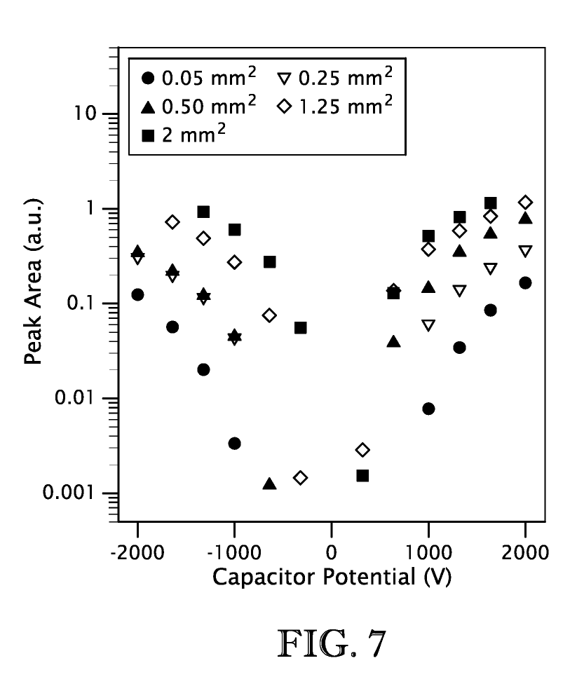

FIG. 7 shows how the actuator response (peak area) behaves as a function of both increasing V_{cap} and active capacitor area. Here, the y-axis is plotted as a log value to accentuate the differences between peaks with small areas. Again for any particular capacitor area, the change in peak area appears to increase quadratically as a function of the electric field across the EAP. The peak area is also seen to increase as a function of the active capacitor area.

The data in FIG. 7 also demonstrate two other important characteristics about the device performance. First, the range of external voltages (V_{cap}=320 to 2,000 V) applied to the largest active capacitors, 1.25 and 2 mm², generated injection plugs whose volumes could be tuned over approximately 3 orders of magnitude (from 0.0015 to 1.15 peak area units in FIG. 7). Second, the positive and negative values of V_{cap} prior to capacitor discharging produced peaks with different areas even though theoretically the magnitude of the Maxwell stress should not be dependent on the polarity of the electric field across the EAP layer. Though not wishing to be bound by theory, the cause of this discrepancy may be related to the fact that PDMS is thought to preferentially adsorb negative ions, and this may affect the inductive charge generation at the surface of the liquid electrode. Another possibility is that the electric field across the EAP may have a very small effect on the EOF via a change in the zeta potential on the channel wall.

### Example 5

### Dependence of Injection Volume on the Elasticity of the EAP

In addition to the size of the active capacitor area and the magnitude of the electric field across the EAP layer, injection volume was also examined as a function of EAP layer composition. Devices were fabricated using three different EAP compositions: 10:1 (w/w) (elastomer base:curing agent) Sylgard 184, 20:1 (w/w) Sylgard 184, and 3:1 (w/w) mixture of 1:1 (w/w) Sylgard 527/10:1 (w/w) Sylgard 184. With these EAP compositions, differences in the amount of cross-linking and silica content create polymers that have differing amounts of elasticity. Stress-strain curves for each polymer composition were recorded. At a strain of 10%, it was determined that the 10:1 PDMS had a secant modulus of 2.3±0.3 MPa, and the 20:1 PDMS had a secant modulus of 0.52±0.03 MPa. This means that the 20:1 elastomer was more deformable than the 10:1 elastomer. The elasticity of the 3:1 Sylgard 527/Sylgard 184 elastomer could not be measured because of its low tensile strength, but a Shore Durometer measurement gave a hardness value of 14 compared to 29 and 58 (all values on scale A) for the 20:1 and 10:1 Sylgard 184, respectively. The results of the Shore Durometer readings show that the 3:1 Sylgard 527/Sylgard 184 composite is the softest material of the three. Although not measureable, it was estimated that the secant modulus of the 3:1 Sylgard 527/Sylgard 184 mixture used was between 0.52 MPa and 0.068 MPa, making it more deformable than either of the 10:1 or 20:1 PDMS EAPs.

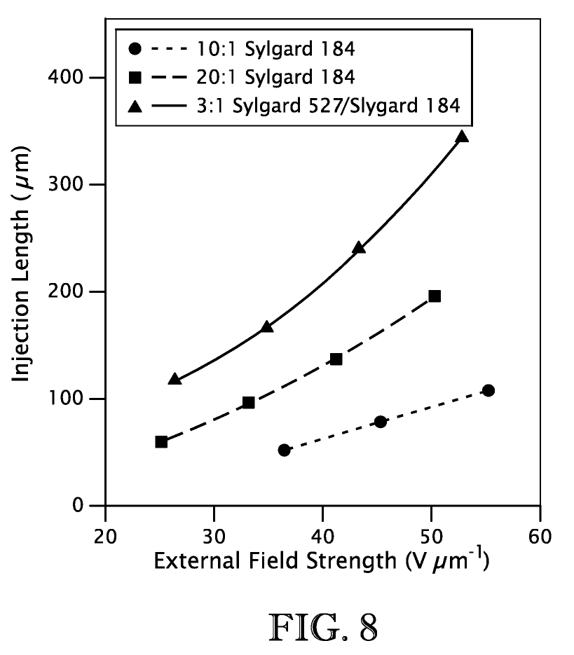

FIG. 8 shows the size of injections on the three devices with different EAP layer compositions. Each device had an active capacitor area of 0.25 mm² and the intersection-fixed electrode distances for all three electrodes were between 460 and 585 μm. In order to examine the effects of EAP elasticity on the injection volume, injections of 20 μM DCF were performed at a field strength of 500 V/cm. This data was obtained by plotting spatial peak variance as a function of migration time for a set of 5 different separation distances. As can be seen in FIG. 8, the injection size at a specific external field strength varied inversely with the elasticity of the dielectric. In addition, the response of EAP layers made from softer elastomers increased more rapidly as a function of electric field strength across the EAP layer. These observations are consistent with the predicted relationship between the theoretical thickness strain and the electric field strength for EAP layers with differing elasticity.

### Example 6

### Comparison of Separation Efficiency Between Electrokinetic and Hydrodynamic Injections in Micro-Capillary Electrophoresis

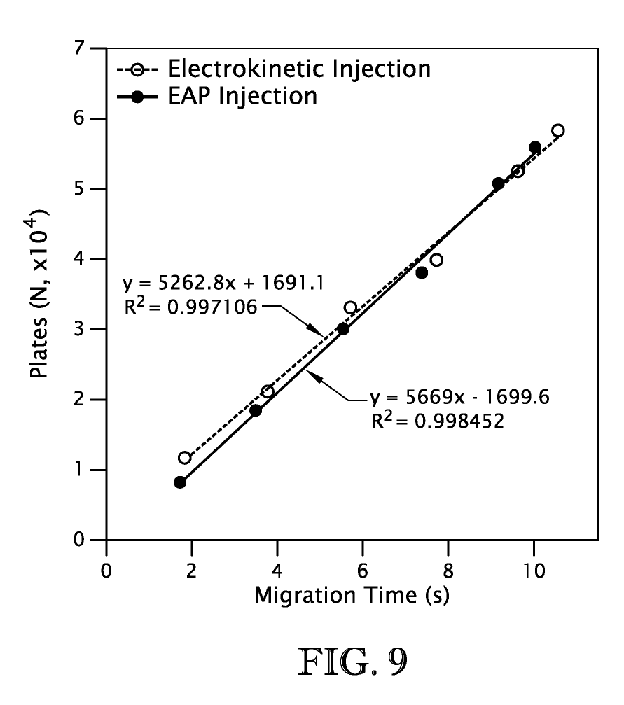

Employing micro-fluidic devices prepared as described above in Example 1, a comparison was made between the inventive hydrodynamic injections and conventional electrokinetic injections on micro-fluidic devices. FIG. 9 shows a plot of peak efficiency as a function of migration time for six sets of pentuplicate injections. For each type of injection, the sample consisted of 2.72 μM FITC-labeled arginine (“FITC-Arg”), proline (“FITC-Pro”), and glutamic acid (“FITC-Glu”) in the run buffer, which was 10 mM sodium borate and 5 mM SDS (pH=9.5). Plugs of analyte were separated at a field strength of 500 V/cm and detected at six different locations along the separation channel. These locations corresponded to separation distances of 0.5 cm, 1.008 cm, 1.516 cm, 2.024 cm, 2.532 cm, and 2.786 cm. Electrokinetic injections were made by lowering the potential in the buffer reservoir from 3,160 V to 1,960 V for 0.02 seconds. Injections employing EAP actuation were made by changing V_{cap} from 1,000 V to 0 V on a device with a 0.5 mm² actuator area and a mean EAP thickness of 40.00 μm. The data in FIG. 9 show that the rate of FITC-Arg plate generation for EAP actuated injections was analogous to electrokinetic injections under similar separation conditions. Discrepancies in migration time may have been due to differences in electroosmotic flow (“EOF”) resulting from variance in PDMS composition between devices and perhaps a global effect related to the charge generation on the EAP actuator unit. Furthermore, the linearity of the data suggests that separations with both types of injection are diffusion-limited. In physical terms, this suggests that the mechanical action of the EAP actuator unit does not significantly impact separation performance. Data comparing the rates of plate generation for FITC-Pro and FITC-Glu as well as resolution data using each injection method are provided below in Tables 1 and 2, respectively.

TABLE 1
Plate Generation Data for FITC-Pro and FITC-Glu

| | | | |
|---|---|---|---|
| FITC-Pro | EK | y = 3830x + 1760 | R² = 0.997 |
| | EAP | y = 4040x − 239 | R² = 0.999 |
| FITC-Glu | EK | y = 3040x + 1430 | R² = 0.995 |
| | EAP | y = 3400x − 954 | R² = 0.998 |

TABLE 2
Resolution Data for FITC-Labeled Amino Acids at
Two Separation Distances

| | EK | EAP | EK | EAP |
|---|---|---|---|---|
| Peak₁-Peak₂ | 0.500 cm | 0.500 cm | 2.786 cm | 2.786 cm |
| Arg-Pro | 4.8 | 4.0 | 11.3 | 10.9 |
| Arg-Glu | 8.2 | 6.9 | 19.5 | 19.1 |
| Pro-Glu | 3.6 | 3.0 | 8.4 | 8.2 |

### Example 7

### Injection Reproducibility

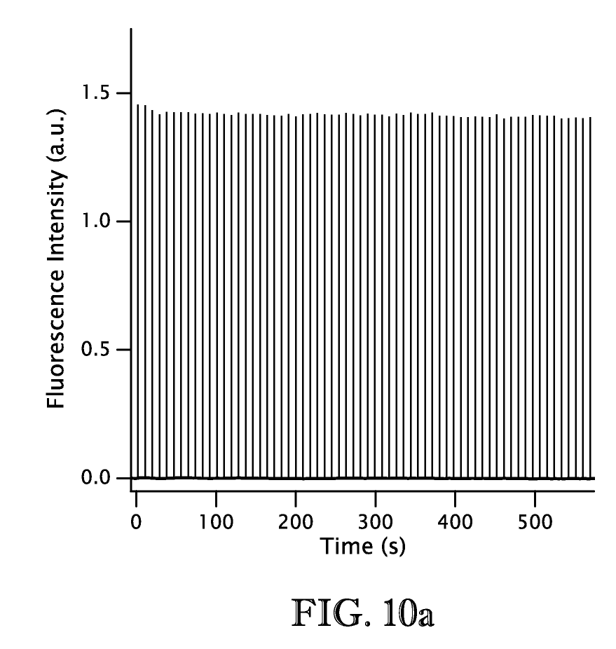

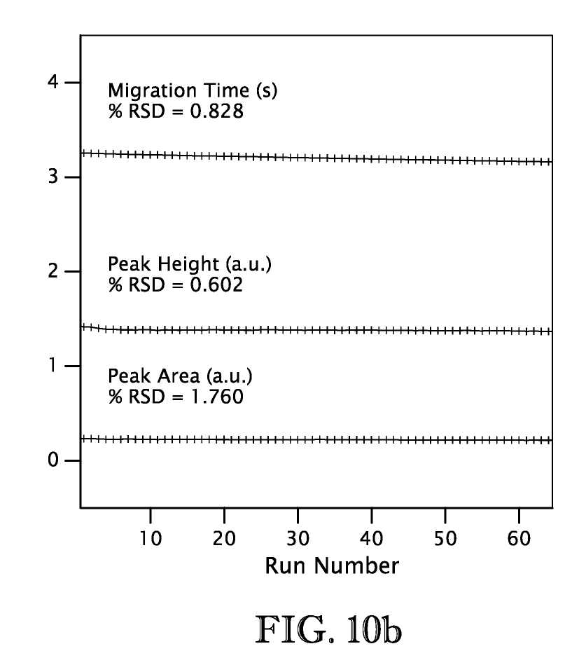

In order to demonstrate the reproducibility of the EAP actuated injections, 64 consecutive injections were performed on a microfluidic device prepared as described in Example 1. The electropherogram in FIG. 10a shows injections of 15 μM DCF in the run buffer, which was 10 mM sodium borate (pH=9.2). The microfluidic device used for this example had an actuator area of 0.25 mm² and a mean EAP thickness of 40.48 μm. Injections were made by changing V_{cap} from −1,320 V to 0 V and plugs of analyte were detected 0.5 cm downstream of the injection cross. The injection sequence consisted of 8-second run times with 1 second between the charging and discharging of the EAP actuator unit; the total run time was 580 seconds.

The graph in FIG. 10b plots migration time, peak height, and peak area (three different indicators of injection and separation reproducibility) for each of the 64 injections shown in FIG. 10a. The average migration time for these injections was 3.204±0.027 seconds. Though not wishing to be bound by theory, the variation in migration time that is present between run 1 (3.255 s) and run 64 (3.163 s) may be due to a combination of (a) changes in EOF resulting from analyte adsorption to the channel wall and (b) changes in the hydrostatic pressure resulting from a change in the reservoir liquid level heights during chip operation. The average values for the peak height and peak area are 1.380±0.008 and 0.222±0.004, respectively. Each of the indicators of reproducibility has a relative standard deviation (“RSD”) less than 2%, which is better than or equal to numerous other conventional pressure-based injection strategies.

The data in FIGS. 10a and 10b imply that there is minimal hysteretic behavior present with the operation of the EAP actuator unit. Indeed, it has been reported that EAP actuation at low strains is very reproducible over thousands of voltage cycles. Though not wishing to be bound by theory, it is thought that the majority of the actuator reproducibility has two origins. The first is that there are no intricate or fragile moving parts, only the elastomeric EAP layer, which is mechanically robust. The second is that the volume of the injection is dependent mainly upon the magnitude of V_{cap}, and the time component to the injection is limited to allowing adequate time between EAP charging and discharging (i.e., for the fluid to completely fill the excess channel volume above the EAP actuator unit before it is expelled into the separation channel.

### Example 8

### Sampling Bias Comparison for Electrokinetic and EAP-Actuated Injections

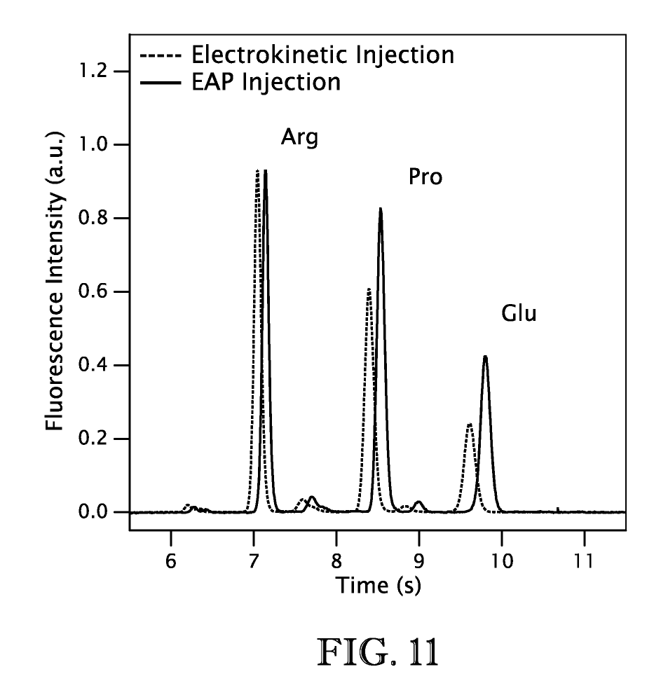

FIG. 11 is an electropherogram of a mixture of FITC-labeled amino acids using both a gated electrokinetic injection and an EAP-actuated injection on microfluidic devices prepared as described in Example 1. The samples contained 2.72 μM FITC-labeled arginine, proline, and glutamic acid in the run buffer, which was 10 mM sodium borate and 5 mM SDS (pH=9.5). For the purpose of comparison, the height of each arginine peak was normalized. In each injection method, the analytes were separated at a field strength of 500 V/cm and detected 2.00 cm downstream of the intersection. The electrokinetic injection had a 0.02-second inject phase in which the potential in the buffer introduction reservoir was decreased from 3,160 V to 1,960 V. The EAP-actuated injection was performed by changing V_{cap} from −1,000 V to 0 V on a device with an actuator area of 0.5 m² and a mean EAP thickness of 42.62 μm. From the electropherogram, it is evident that the EAP-actuated injections contained a different relative chemical composition than the electrokinetic injections. The noticeably larger spread of peak heights present in the electrokinetic injection suggests a large amount of sample bias. This is expected since FITC-Arg, FITC-Pro, and FITC-Glu have two, three, and four nominal negative charges, respectively, at pH 9.5; thus, FITC-Arg is repelled least and FITC-Glu is repelled most from the buffer waste reservoir. Though not wishing to be bound by theory, discrepancies in migration times may be due to small differences in the EOF or field strength as the two separations were performed on different devices.

### Example 9

### Comparison of Peak Area Percentage and Injection Volume for Electrokinetic and EAP-Actuated Injections

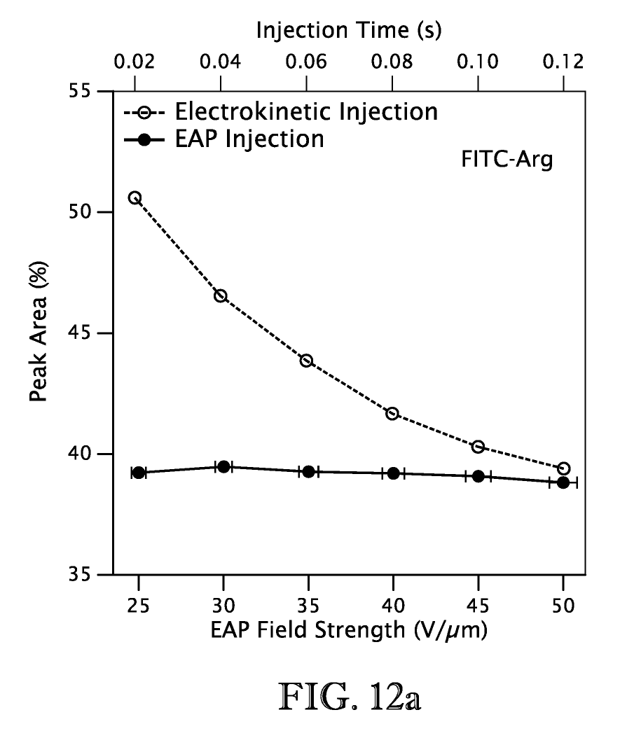

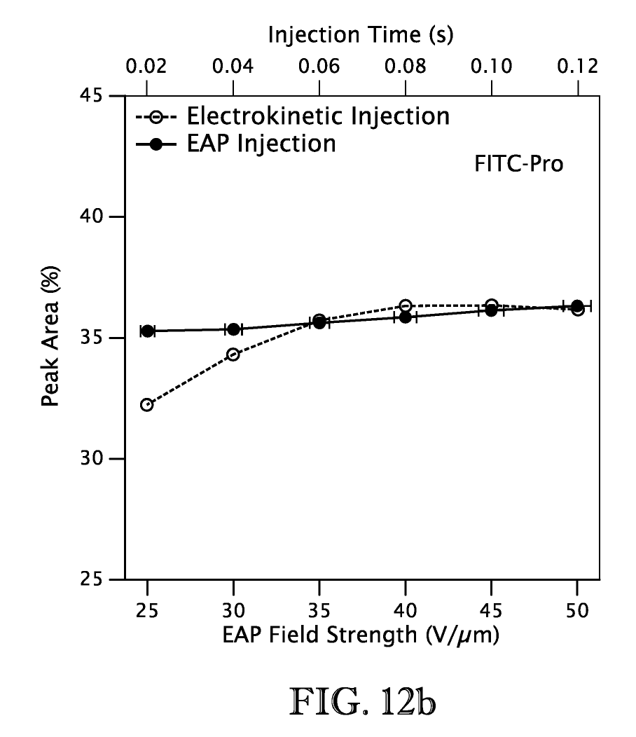

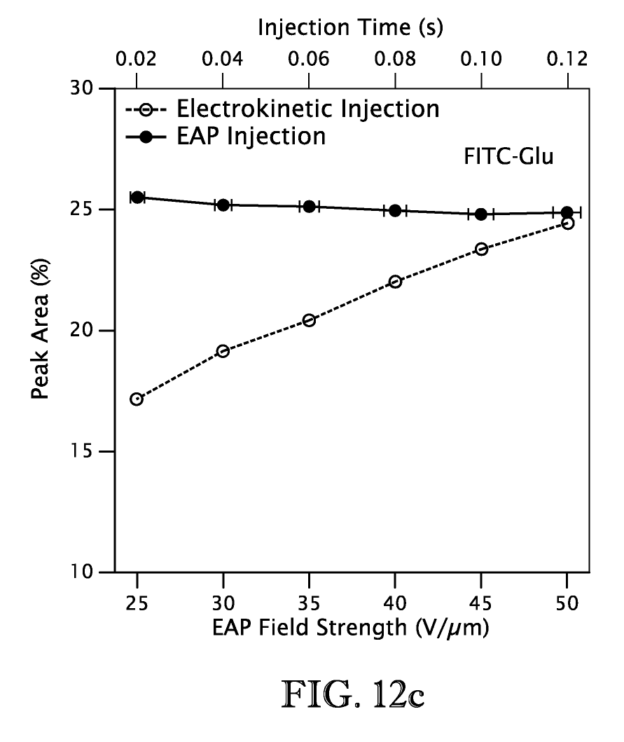

Using the same amino acid mixture described above in Example 8, the relationship between peak area percentage and injection volume for both electrokinetic and EAP-actuated sample introduction was investigated. FIGS. 12a-c show the peak area percentages obtained for each amino acid employing these two different injection methods. For all injections, the analytes were separated at a field strength of 500 V/cm and detected 2.0 cm downstream of the injection cross. The electrokinetic and EAP-actuated injections were performed on the same device. During electrokinetic injections, V_{electrode} was held constant at V_{channel} while the potential in the buffer introduction reservoir was decreased from 3,160 V to 1,960 V. The respective time gates for the 6 sets of electrokinetic injections were 0.02, 0.04, 0.06, 0.08, 0.10, and 0.12 seconds. The 6 sets of EAP-actuated injections were performed by respectively changing V_{cap} from −1,000, −1,200, −1,400, −1,600, −1,800, and −2,000 V to 0 V across an EAP layer with a mean thickness of 40.00 μm and an actuator area of 0.50 mm².

As can be seen in FIGS. 12a-c, it is evident that the chemical composition of the EAP-actuated injections was very stable as a function of injection volume. The range of total peak area between the smallest injection (ΔV_{cap}=1,000 V) and the largest (ΔV_{cap}=2,000 V) was 0.046-0.513 (arbitrary units). Over this range, the mean arginine, proline, and glutamic acid peak area percentages for all 30 injections were 39.18±0.21%, 35.75±0.39%, and 25.06±0.24%, respectively. Conversely, the behavior of the peak area percentages for electrokinetic sampling as the injection volume increased was consistent with theoretical studies. That is, the peak area percentages for a mixture of analytes will asymptotically approach the true peak area percentages of the sample as the injection volume increases. It is obvious from the data that the smallest electrokinetic injections (0.02 s, 0.133 total peak area) were very biased, with the largest discrepancies for the amino acids with the highest and lowest apparent mobilities. Smaller electrokinetic injections, comparable with the smallest EAP-actuated injections, would experience even more extreme sampling bias. Only the largest electrokinetic injections (0.12 s, 1.364 total peak area) seem to possess the true peak area percentage for all three amino acids.

### DEFINITIONS

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

### NUMERICAL RANGES

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

The present description uses specific numerical values to quantify certain parameters relating to the invention, where the specific numerical values are not expressly part of a numerical range. It should be understood that each specific numerical value provided herein is to be construed as providing literal support for a broad, intermediate, and narrow range. The broad range associated with each specific numerical value is the numerical value plus and minus 60 percent of the numerical value, rounded to two significant digits. The intermediate range associated with each specific numerical value is the numerical value plus and minus 30 percent of the numerical value, rounded to two significant digits. The narrow range associated with each specific numerical value is the numerical value plus and minus 15 percent of the numerical value, rounded to two significant digits. For example, if the specification describes a specific temperature of 62° F., such a description provides literal support for a broad numerical range of 25° F. to 99° F. (62° F.+/−37° F.), an intermediate numerical range of 43° F. to 81° F. (62° F.+/−19° F.), and a narrow numerical range of 53° F. to 71° F. (62° F.+/−9° F.). These broad, intermediate, and narrow numerical ranges should be applied not only to the specific values, but should also be applied to differences between these specific values. Thus, if the specification describes a first pressure of 110 psia and a second pressure of 48 psia (a difference of 62 psi), the broad, intermediate, and narrow ranges for the pressure difference between these two streams would be 25 to 99 psi, 43 to 81 psi, and 53 to 71 psi, respectively.

### CLAIMS NOT LIMITED TO DISCLOSED EMBODIMENTS

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. An actuator for use on a microfluidic device, said actuator comprising:
(a) an electrode;
(b) a fluidic layer having a recessed portion formed therein; and
(c) an electroactive polymer layer underlying at least a portion of said fluidic layer,
wherein at least a portion of said electroactive polymer layer cooperates with said recessed portion of said fluidic layer to define a fluid-conducting channel,
wherein said electrode underlies at least a portion of said fluid-conducting channel.

2. The actuator of claim 1, wherein said electroactive polymer comprises a dielectric elastomer.

3. The actuator of claim 1, wherein said electroactive polymer is selected from the group consisting of poly(dimethylsiloxane), a poly(dimethylsiloxane)/poly(ethylene oxide) copolymer, a fluorosilicone, an acrylic polymer, and mixtures of two or more thereof.

4. The actuator of claim 1, wherein said electroactive polymer comprises poly(dimethylsiloxane).

5. The actuator of claim 1, wherein said fluidic layer comprises one or more polymers.

6. The actuator of claim 1, wherein said fluidic layer comprises one or more materials selected from the group consisting of poly(dimethylsiloxane), a poly(dimethylsiloxane)/poly(ethylene oxide) copolymer, a fluorosilicone, an acrylic polymer, glass, and mixtures of two or more thereof.

7. The actuator of claim 1, wherein said fluidic layer comprises poly(dimethylsiloxane).

8. The actuator of claim 1, further comprising a substrate layer, wherein said electrode is disposed on said substrate layer.

9. The actuator of claim 8, wherein said substrate layer comprises a material selected from the group consisting of glass, one or more plastics, and mixtures thereof.

10. The actuator of claim 1, wherein said electroactive polymer layer has an average thickness in the range of from about 5 to about 200 μm.

11. The actuator of claim 1, wherein said fluidic layer has an average thickness above said fluid-conducting channel in the range of from about 0.1 mm to about 5 cm.

12. The actuator of claim 1, wherein a vertical cross-section of said fluid-conducting channel is substantially quadrilateral.

13. The actuator of claim 1, wherein said fluid-conducting channel has an average width in the range of from about 1 to about 500 μm.

14. The actuator of claim 1, wherein said channel has an average depth in the range of from about 1 to about 100 μm.

15. The actuator of claim 1, wherein said actuator has a horizontal cross-sectional area in the range of from about 0.01 to about 5 mm2.

16. The actuator of claim 1, wherein said electrode is a fixed electrode.

17. The actuator of claim 1, wherein said electrode comprises at least one material selected from the group consisting of one or more metals, carbon graphite, indium tin oxide, or mixtures of two or more thereof.

18. The actuator of claim 1, wherein said electrode is formed via photolithography.

19. A microfluidic device comprising the actuator of claim 1.

20. The microfluidic device of claim 19, further comprising a power supply, wherein said electrode is electrically coupled to said power supply.

21. The microfluidic device of claim 19, further comprising a buffer solution and an analyte-containing fluid, wherein said fluidic layer further comprises a buffer-conducting channel operable to transport said buffer solution, and an analyte-conducting channel operable to transport said analyte-containing fluid.

22. The microfluidic device of claim 21, wherein a portion of said analyte-conducting channel constitutes said fluid-conducting channel of said actuator.

23. The microfluidic device of claim 21, wherein said buffer-conducting channel and said analyte-conducting channel intersect to form an intersection.

24. The microfluidic device of claim 23, wherein the distance between said actuator and said intersection is less than about 1,000 μm.

25. The microfluidic device of claim 23, wherein the distance between said actuator and said intersection is in the range of from about 200 to about 800 μm.

26. The microfluidic device of claim 21, further comprising a buffer introduction reservoir, a buffer waste reservoir, an analyte introduction reservoir, an analyte waste reservoir, and a power supply, wherein said buffer-conducting channel is in fluid flow communication with said buffer introduction reservoir and said buffer waste reservoir, wherein said analyte-conducting channel is in fluid flow communication with said analyte introduction reservoir and said analyte waste reservoir, wherein said buffer introduction reservoir and said analyte introduction reservoir are electrically coupled to said power supply.

27. The microfluidic device of claim 21, further comprising a check valve disposed in said fluid-conducting channel.

28. A microfluidic device comprising a plurality of actuators according to claim 1.

29. (canceled)

30. The process of claim 33, wherein said electroactive polymer comprises a dielectric elastomer.

31. The process of claim 33, wherein said electroactive polymer is selected from the group consisting of poly(dimethylsiloxane), a poly(dimethylsiloxane)/poly(ethylene oxide) copolymer, a fluorosilicone, an acrylic polymer, and mixtures of two or more thereof.

32. The process of claim 33, wherein said electroactive polymer comprises poly(dimethylsiloxane).

33. A process for creating a hydrodynamic force in a microfluidic device so as to cause a fluid to flow in said device, said process comprising: applying a potential difference across an electroactive polymer disposed on said microfluidic device and in communication with said fluid thereby causing said electroactive polymer to deform, wherein said fluid comprises a buffer.

34. The process of claim 33, wherein said buffer is selected from the group consisting of sodium borate, sodium phosphate, MES, ADA, PIPES, ACES, cholamine chloride, BES, TES, HEPES, acetamidoglycine, tricine, blycinamide, bicine, and mixtures of two or more thereof.

35. A process for creating a hydrodynamic force in a microfluidic device so as to cause a fluid to flow in said device, said process comprising: applying a potential difference across an electroactive polymer disposed on said microfluidic device and in communication with said fluid thereby causing said electroactive polymer to deform, wherein said fluid comprises an analyte.

36. The process of claim 35, wherein said analyte is selected from the group consisting of proteins, DNA, RNA, amino acids, PAHs, PCBs, steroids, and mixtures of two or more thereof.

37. A process for creating a hydrodynamic force in a microfluidic device so as to cause a fluid to flow in said device, said process comprising: applying a potential difference across an electroactive polymer disposed on said microfluidic device and in communication with said fluid thereby causing said electroactive polymer to deform, wherein said applied potential difference causes a Maxwell stress in said electroactive polymer in the range of from about 0.01 to about 60 kPa.

38. The process of claim 37, wherein said microfluidic device further comprises an electrode and a fluid-conducting channel comprising said fluid, wherein said electroactive polymer is disposed between said electrode and said fluid-conducting channel.

39. The process of claim 38, wherein said potential difference is applied by charging said electrode.

40. The process of claim 39, wherein said electrode is charged by a power supply having a slew rate of less than 5 milliseconds.

41. The process of claim 38, further comprising charging said fluid in said fluid-conducting channel.

42. The process of claim 38, wherein said electrode is disposed on a substrate.

43. The process of claim 38, wherein said deformation causes an increase in volume of said fluid-conducting channel.

44. The process of claim 38, wherein said microfluidic device further comprises a fluidic layer, wherein the inner surface of said fluid-conducting channel is partially defined by said fluidic layer and partially defined by said electroactive polymer.

45. The process of claim 38, wherein said fluidic layer comprises a polymer.

46. The process of claim 38, wherein said potential difference across said electroactive polymer is in the range of from about 1 to about 100 V per micrometer of electroactive polymer extending between said electrode and said fluid-conducting channel.
